(19) United States
(12) Patent Application Publication
(10) Pub. No.: US 2025/0296874 A1
(43) Pub. Date: Sep. 25, 2025

(54) ETCHING APPARATUS AND METHOD OF MANUFACTURING WINDOW

(71) Applicant: Samsung Display Co., LTD., Yongin-si (KR)

(72) Inventors: SEUNGJUN LEE, Yongin-si (KR); JAE HOON JEONG, Yongin-si (KR); BEOMSOO KIM, Yongin-si (KR); ILSOO JANG, Yongin-si (KR)

(21) Appl. No.: 19/051,973

(22) Filed: Feb. 12, 2025

(30) Foreign Application Priority Data
Mar. 25, 2024 (KR) 10-2024-0040646

(51) Int. Cl. C03C 15/00

(52) U.S. Cl. CPC C03C 15/00

(57) ABSTRACT

An etching apparatus includes a base part and an etching part disposed on the base part. The etching part includes a support bar, a foam coupled with one end of the support bar and provided with a plurality of pores, and an etching solution provided in the pores. The one end is adjacent to the base part.

This application claims priority to Korean Patent Application No. 10-2024-0040646, filed on Mar. 25, 2024, and all the benefits accruing therefrom under 35 U.S.C. § 119, the content of which in its entirety is herein incorporated by reference.

### BACKGROUND

### 1. Field

The present disclosure relates to an etching apparatus and a method of manufacturing a window. More particularly, the present disclosure relates to an etching apparatus capable of manufacturing a foldable window and a method of manufacturing the foldable window.

### 2. Description of Related Art

A display device includes a display area that is activated in response to electrical signals. The display device senses an input applied thereto from the outside through the display area and displays images to provide a user with information through the display area. In recent years, the display devices of a variety of shapes are being developed, and particularly, researches on foldable display devices are actively being conducted. Accordingly, an efficient etching method for an ultra-thin glass (“UTG”) is desirable to implement foldable properties.

### SUMMARY

The present disclosure provides an etching apparatus capable of manufacturing a window with foldable characteristics at low cost and through a simple process.

The present disclosure provides a method of manufacturing the window with foldable characteristics at low cost and through a simple process.

Embodiments of the invention provide an etching apparatus including a base part and an etching part disposed on the base part. The etching part includes a support bar, a foam coupled with one end of the support bar and provided with a plurality of pores, and an etching solution provided in the pores. The one end is adjacent to the base part.

The support bar may include a plurality of unit support bars, and the foam may include a plurality of unit foams coupled with one end of the unit support bars, respectively.

A distance between one unit support bar among the unit support bars and the other unit support bar adjacent to the one unit support bar may be equal to or greater than about 45 millimeters (mm) and equal to or smaller than about 500 mm.

The base part and the support bar may include an acid-resistance material.

The acid-resistance material may include a plastic material.

The foam may include a melamine resin.

The etching solution may include at least one of ammonium fluoride, sulfuric acid, and nitric acid.

The etching solution may include the ammonium fluoride, the sulfuric acid, and the nitric acid. The ammonium fluoride may be in an amount equal to or more than 10 weight percentages (wt %) and equal to or less than 15 wt % by weight of the etching solution, the sulfuric acid may be in an amount equal to or more than 2 wt % and equal to or less than 7 wt % by weight of the etching solution, and the nitric acid may be in an amount equal to or more than 1 wt % and equal to or less than 5 wt % by weight of the etching solution.

The foam may have a diameter equal to or greater than about 40 mm and equal to or smaller than about 60 mm in a plan view.

The etching apparatus may further include a moving part coupled with the etching part.

The moving part may move the etching part in one direction and a direction opposite to the one direction.

The moving part may include a rail part including a first rail disposed adjacent to one side of the base part and extending in the one direction and a second rail disposed opposite to the first rail with respect to the base part and extending in the one direction and a joint part including a first-rail joint part coupled with the first rail, a second-rail joint part coupled with the second rail, and a support bar joint part coupled with the support bar.

Embodiments of the invention provide a method of manufacturing a window. The method includes providing a base part and a target substrate disposed on the base part, placing an etching part, which includes a support bar, a foam provided with a plurality of pores, and an etching solution provided in the pores, on the target substrate, where the form is coupled with one end of the support bar adjacent to the target substrate, and moving the etching part alternately in one direction and in a direction opposite to the one direction to etch a portion of the target substrate and to form a pattern on the target substrate.

A diameter of an area where the foam is in contact with the target substrate may be equal to or greater than about 20 mm and equal to or smaller than about 40 mm in a plan view in the placing of the etching part.

The etching part may alternately move in the one direction and the direction opposite to the one direction, respectively, about 200 times or more and about 1000 times or less in the forming of the pattern.

The target substrate may include a glass material.

The target substrate may include a first non-folding area, a second non-folding area spaced apart from the first non-folding area, and a folding area disposed between the first non-folding area and the second non-folding area in a plan view, and the pattern may be formed in the folding area.

The pattern may be provided with a recess defined in the folding area and extending in the one direction, and a depth of the recess may be smaller than a thickness of the target substrate.

The etching part may be coupled with a moving part, and the moving part may move the etching part in the one direction or the direction opposite to the one direction.

The moving part may include a rail part including a first rail disposed adjacent to one side of the base part and extending in the one direction and a second rail disposed opposite to the first rail with respect to the base part and extending in the one direction and a joint part including a first-rail joint part coupled with the first rail, a second-rail joint part coupled with the second rail, and a support bar joint part coupled with the support bar.

According to the above, the window having foldable characteristics is manufactured using the etching apparatus manufactures at low cost and through a simple process using the etching solution.

According to the above, the window having foldable characteristics is manufactured using the manufacturing method of the window that allows the foam including the etching solution to be directly in contact with the target substrate, and thus, the production cost is reduced and the process difficulty is effectively improved.

### BRIEF DESCRIPTION OF THE DRAWINGS

The above and other advantages of the present disclosure will become readily apparent by reference to the following detailed description when considered in conjunction with the accompanying drawings wherein:

FIGS. 1A to 1C are perspective views of an electronic device according to an embodiment of the present disclosure;

FIG. 2A is an exploded perspective view showing an electronic device according to an embodiment of the present disclosure;

FIG. 2B is a block diagram showing an electronic device according to an embodiment of the present disclosure;

FIG. 3A is a plan view showing a display panel according to an embodiment of the present disclosure;

FIG. 3B is a plan view showing a portion of a display panel according to an embodiment of the present disclosure;

FIGS. 4 and 5 are perspective views of an etching apparatus according to an embodiment of the present disclosure;

FIG. 6 is a cross-sectional view taken along line I-I′ of FIG. 5;

FIG. 7 is a flowchart illustrating a method of manufacturing a window according to an embodiment of the present disclosure;

FIGS. 8 to 11 are views illustrating of a method of manufacturing a window according to an embodiment of the present disclosure; and

FIG. 12 is a cross-sectional view taken along line II-II′ of FIG. 11.

### DETAILED DESCRIPTION

In the present disclosure, it will be understood that when an element (or area, layer, or portion) is referred to as being “on”, “connected to” or “coupled to” another element or layer, it can be directly on, connected or coupled to the other element or layer or intervening elements or layers may be present.

Like numerals refer to like elements throughout. In the drawings, the thickness, ratio, and dimension of components are exaggerated for effective description of the technical content. As used herein, the term “and/or” may include any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the teachings of the present disclosure. As used herein, the singular forms, “a”, “an” and “the” are intended to include the plural forms as well, unless the context clearly indicates otherwise.

Spatially relative terms, such as “beneath”, “below”, “lower”, “above”, “upper” and the like, may be used herein for ease of description to describe one element or feature's relationship to another elements or features as shown in the figures.

It will be further understood that the terms “include” and/or “including”, when used in this specification, specify the presence of stated features, integers, steps, operations, elements, and/or components, but do not preclude the presence or addition of one or more other features, integers, steps, operations, elements, components, and/or groups thereof.

In the present disclosure, it will be understood that when an element such as a layer, film, region, or substrate is referred to as being “on” another element, it may be “directly on” the other element or intervening elements may also be present. In contrast, it will be understood that when an element such as a layer, film, region, or substrate is referred to as being “under” another element, it may be “directly under” the other element or intervening elements may also be present. In addition, the term “on” in the present disclosure may mean that a portion of an element is disposed at a lower portion as well as an upper portion of another element.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

“About” or “substantially the same” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10%, 5% or 2% of the stated value. Hereinafter, embodiments of the present disclosure will be described with reference to accompanying drawings.

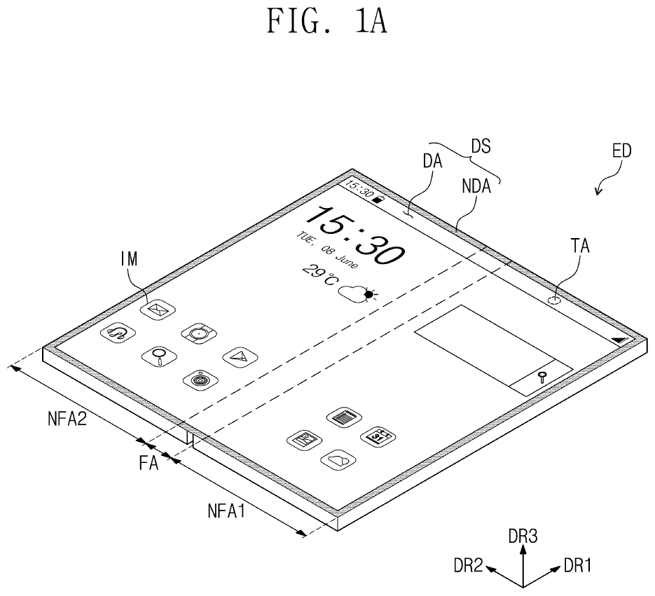

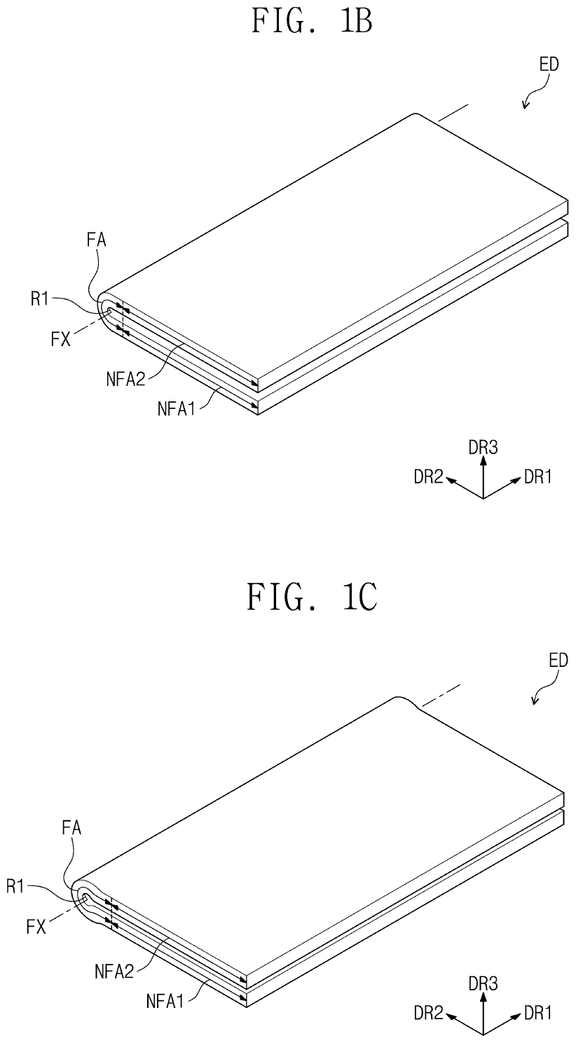

FIGS. 1A to 1C are perspective views of an electronic device ED according to an embodiment of the present disclosure. FIG. 1A shows an unfolded state of the electronic device ED, and FIGS. 1B and 1C show a folded state of the electronic device ED.

Referring to FIGS. 1A to 1C, the electronic device ED may include a display surface DS defined by a first direction DR1 and a second direction DR2 intersecting the first direction DR1. The electronic device ED may provide an image IM to a user through the display surface DS.

The display surface DS may include a display area DA and a non-display area NDA around the display area DA. The display area DA may display the image IM, and the non-display area NDA may not display the image IM. The non-display area NDA may surround the display area DA, however, it should not be limited thereto or thereby, and the shape of the display area DA and the shape of the non-display area NDA may be changed.

The display surface DS may include a sensing area TA. The sensing area TA may be a portion of the display area DA. The sensing area TA may have a light transmittance higher than a light transmittance of the other area of the display area DA. Hereinafter, the other area of the display area DA except the sensing area TA may be defined as an ordinary display area.

An optical signal, e.g., a visible light or an infrared light, may pass through the sensing area TA. The electronic device ED may take a picture of an external object using the visible light passing through the sensing area TA or may determine whether an external object is approaching using the infrared light. FIG. 1A shows one sensing area TA as a representative example, however, the number of the sensing areas TA should not be limited thereto or thereby. According to an embodiment, the sensing area TA may be provided in plural.

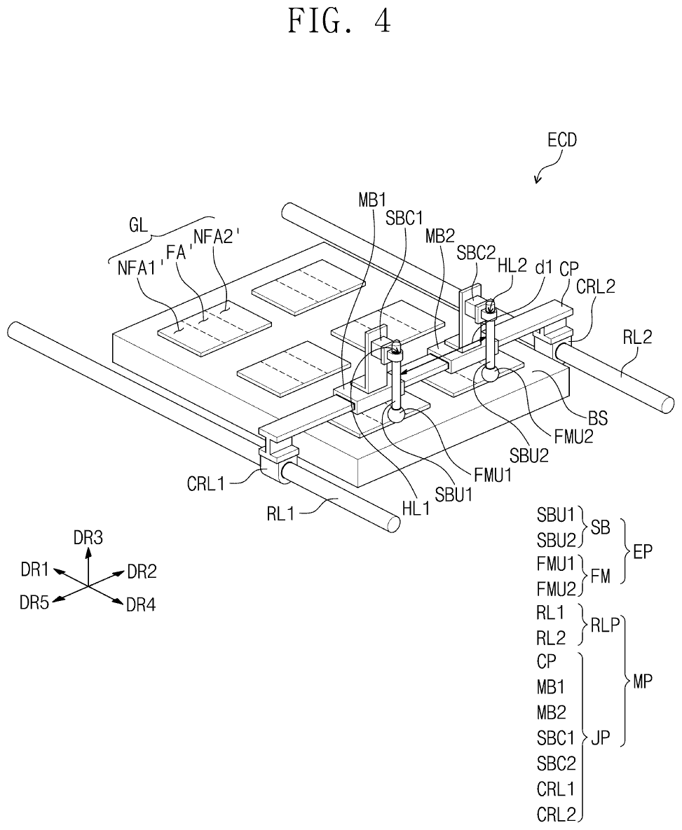

Hereinafter, a direction substantially perpendicular to a plane defined by the first direction DR1 and the second direction DR2 may be referred to as a third direction DR3. The third direction DR3 may be a thickness direction of the base part BS or a target substrate GL (See FIG. 4). Front and rear surfaces of each member of the electronic device ED may be distinguished from each other with respect to the third direction DR3. In the present disclosure, the expression “in a plan view” may mean a state of being viewed in the third direction DR3. Hereinafter, the first, second, and third directions DR1, DR2, and DR3 are directions indicated by first, second, and third directional axes, respectively, and the first, second, and third directional axes are assigned with the same reference numerals as those of the first, second, and third directions DR1, DR2, and DR3.

The electronic device ED may include a folding area FA and a plurality of non-folding areas NFA1 and NFA2. The non-folding areas NFA1 and NFA2 may include a first non-folding area NFA1 and a second non-folding area NFA2. The folding area FA may be disposed between the first non-folding area NFA1 and the second non-folding area NFA2 in the second direction DR2.

As shown in FIG. 1B, the folding area FA may be folded with respect to a folding axis FX substantially parallel to the first direction DR1. The folding area FA may have a predetermined curvature and a radius of curvature R1. The electronic device ED may be inwardly folded (inner-folding) such that the first non-folding area NFA1 faces the second non-folding area NFA2 and the display surface DS is not exposed to the outside.

According to an embodiment, the electronic device ED may be outwardly folded (outer-folding) such that the display surface DS is exposed to the outside. According to an embodiment, the electronic device ED may be provided such that the inner-folding operation or the outer-folding operation is repeated from an unfolding operation. According to an embodiment, the electronic device ED may be provided to carry out any one of the unfolding operation, the inner-folding operation, and the outer-folding operation.

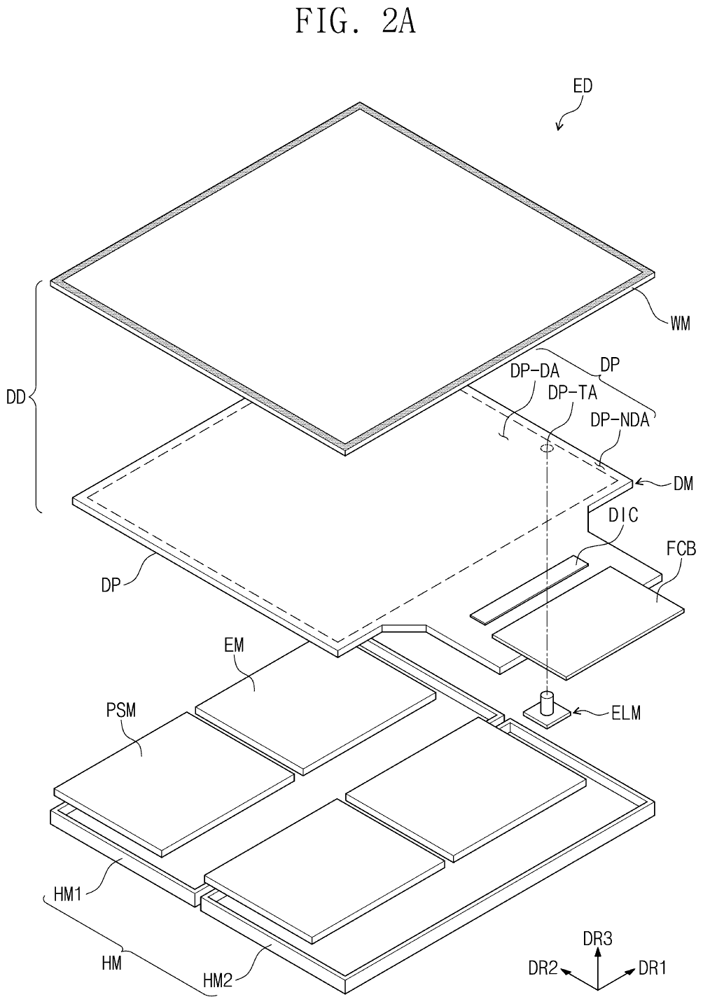

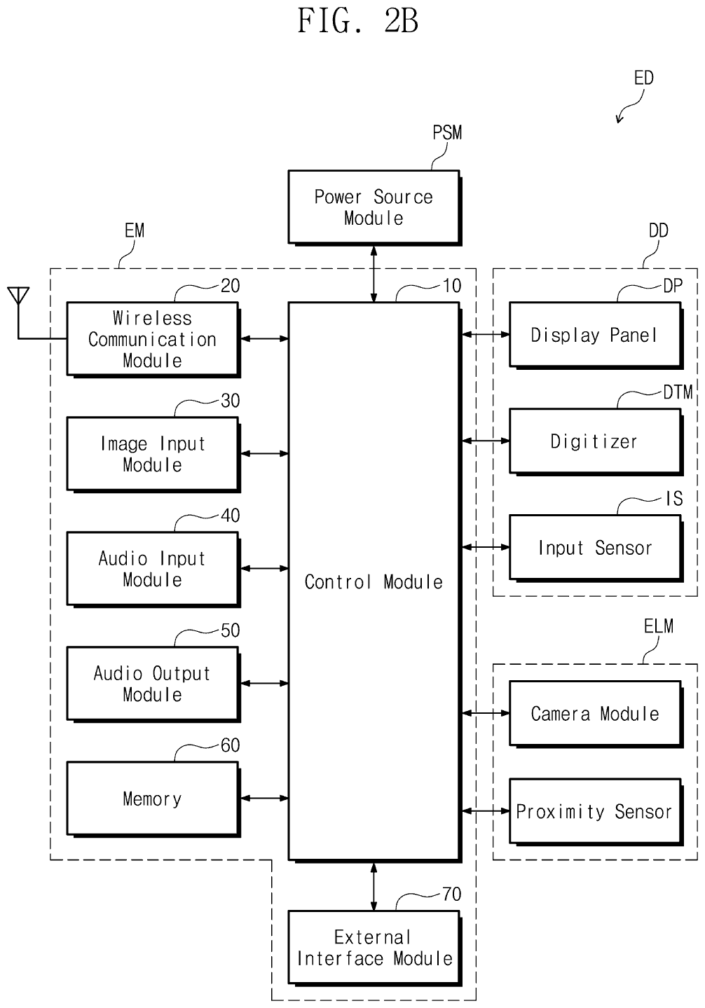

As shown in FIG. 1B, a distance between the first non-folding area NFA1 and the second non-folding area NFA2 may be substantially the same as the radius of curvature R1, however, it should not be limited thereto or thereby. As shown in FIG. 1C, the distance between the first non-folding area NFA1 and the second non-folding area NFA2 may be smaller than the radius of curvature R1. FIGS. 1B and 1C illustrates the electronic device ED based on the display surface DS, and a housing HM (refer to FIG. 2A) that forms an exterior of the electronic device ED may be provided such that a portion of the housing HM at an end portion of the first non-folding area NFA1 may be in contact with another portion of the housing HM at an end of the second non-folding area NFA2.

FIG. 2A is an exploded perspective view showing the electronic device ED according to an embodiment of the present disclosure. FIG. 2B is a block diagram showing the electronic device ED according to an embodiment of the present disclosure.

Referring to FIGS. 2A and 2B, the electronic device ED may include a display device DD, an electronic module EM, an electro-optical module ELM, a power source module PSM, and the housing HM. Although not shown in figures, the electronic device ED may further include a mechanical structure to control a folding operation of the display device DD.

The display device DD may generate an image and may sense an external input. The display device DD may include a window WM and a display module DM. The window WM may provide a front surface of the electronic device ED. The window WM will be described in detail later.

The display module DM may include at least a display panel DP. FIG. 2A shows only the display panel DP among components of the display module DM, which are stacked one on another, however, the display module DM may further include a plurality of components disposed above the display panel DP. Detailed descriptions on a stack structure of the display module DM will be described later.

The display panel DP should not be particularly limited, and the display panel DP may be a light emitting type display panel, for example, an organic light emitting display panel or a quantum dot light emitting display panel. The display panel DP may include an ultra-small light emitting element such as a micro-LED or a nano-LED.

The display panel DP may include a display area DP-DA and a non-display area DP-NDA, which correspond to the display area DA (refer to FIG. 1A) and the non-display area NDA (refer to FIG. 1A) of the electronic device ED, respectively. In the present disclosure, the expression “An area/portion corresponds to another area/portion.” means that “An area/portion overlaps another area/portion.”, however, the “areas and portions” should not be limited to having the same size as each other.

The display panel DP may include a sensing area DP-TA corresponding to the sensing area TA of FIG. 1A. The sensing area DP-TA may have a resolution lower than a resolution of the display area DP-DA.

Referring to FIG. 2A, a driving chip DIC may be disposed in the non-display area DP-NDA of the display panel DP. A flexible circuit board FCB may be attached to the non-display area DP-NDA of the display panel DP. The flexible circuit board FCB may be connected to a main circuit board. The main circuit board may be an electronic component constituting the electronic module EM.

The driving chip DIC may include driving elements to drive pixels of the display panel DP, e.g., a data driving circuit. FIG. 2A shows a structure in which the driving chip DIC is mounted on the display panel DP, however, the present disclosure should not be limited thereto or thereby. As an example, the driving chip DIC may be mounted on the flexible circuit board FCB.

As shown in FIG. 2B, the display device DD may further include an input sensor IS and a digitizer DTM. The input sensor IS may sense a user input. A capacitive type input sensor IS may be disposed above the display panel DP. The digitizer DTM may sense an input generated by a stylus pen. An electromagnetic induction type digitizer DTM may be disposed under the display panel DP.

The electronic module EM may include a control module 10, a wireless communication module 20, an image input module 30, an audio input module 40, an audio output module 50, a memory 60, and an external interface module 70. The electronic module EM may include a main circuit board, and the modules may be mounted on the main circuit board or may be electrically connected to the main circuit board via a flexible circuit board. The electronic module EM may be electrically connected to the power source module PSM.

Referring to FIG. 2A, the electronic module EM may be disposed in each of a first housing HM1 and a second housing HM2, and the power source module PSM may be disposed in each of the first housing HM1 and the second housing HM2. Although not shown in figures, the electronic module EM disposed in the first housing HM1 and the electronic module EM disposed in the second housing HM2 may be electrically connected to each other via a flexible circuit board.

Referring to FIG. 2B again, the control module 10 may control an overall operation of the electronic device ED. For example, the control module 10 may activate or deactivate the display device DD in response to the user input. The control module 10 may control the image input module 30, the audio input module 40, and the audio output module 50 to meet the user input. The control module 10 may include at least one microprocessor.

The wireless communication module 20 may transmit/receive a wireless signal to/from other terminals using a Bluetooth or WiFi link. The wireless communication module 20 may transmit/receive a voice signal using a general communication line. The wireless communication module 20 may include a plurality of antenna modules.

The image input module 30 may process an image signal and may convert the image signal into image data that may be displayed through the display device DD. The audio input module 40 may receive an external audio signal through a microphone in a record mode or a voice recognition mode and may convert the external audio signal to electrical voice data. The audio output module 50 may convert the audio data provided from the wireless communication module 20 or the audio data stored in the memory 60 and may output the converted data to the outside.

The external interface module 70 may serve as an interface between the control module 10 and external devices, such as an external charger, a wired/wireless data port, a card socket (e.g., a memory card and a SIM/UIM card), etc.

The power source module PSM may supply a power source for the overall operation of the electronic device ED. The power source module PSM may include a normal battery device.

The electro-optical module ELM may be an electronic component that outputs or receives an optical signal. The electro-optical module ELM may include a camera module and/or a proximity sensor. The camera module may take a picture of an external object via the sensing area DP-TA (refer to FIG. 2A).

The housing HM shown in FIG. 2A may be coupled to the display device DD, particularly, the window WM to accommodate the above-mentioned modules. The housing HM may include the first and second housings HM1 and HM2 separated from each other, however, it should not be limited thereto or thereby. Although not shown in figures, the housing HM may further include a hinge structure to connect the first and second housings HM1 and HM2 to each other.

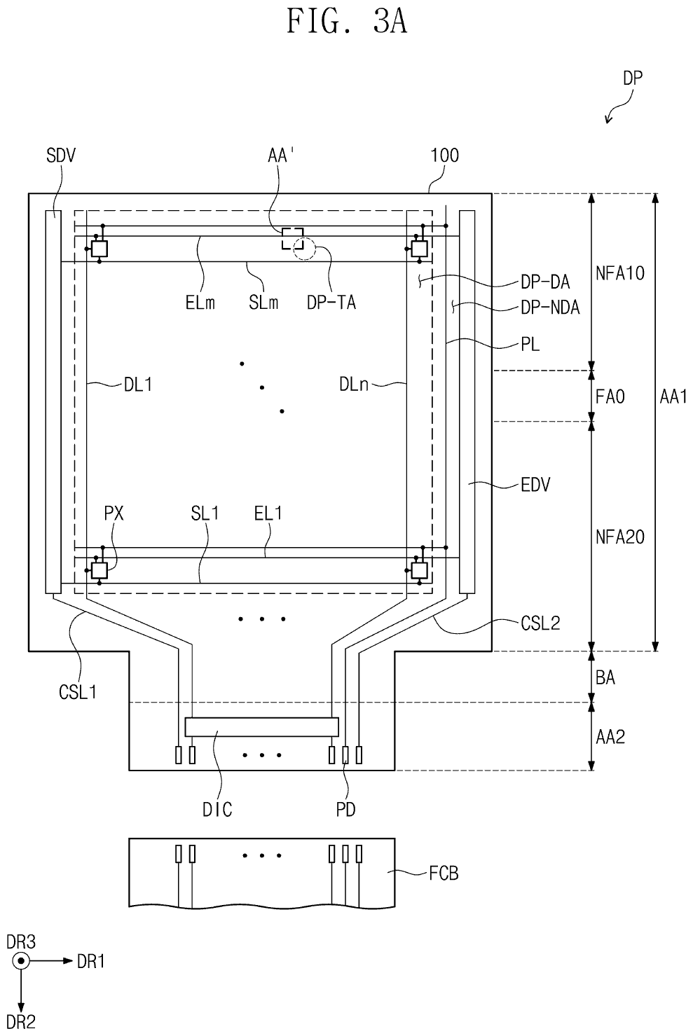

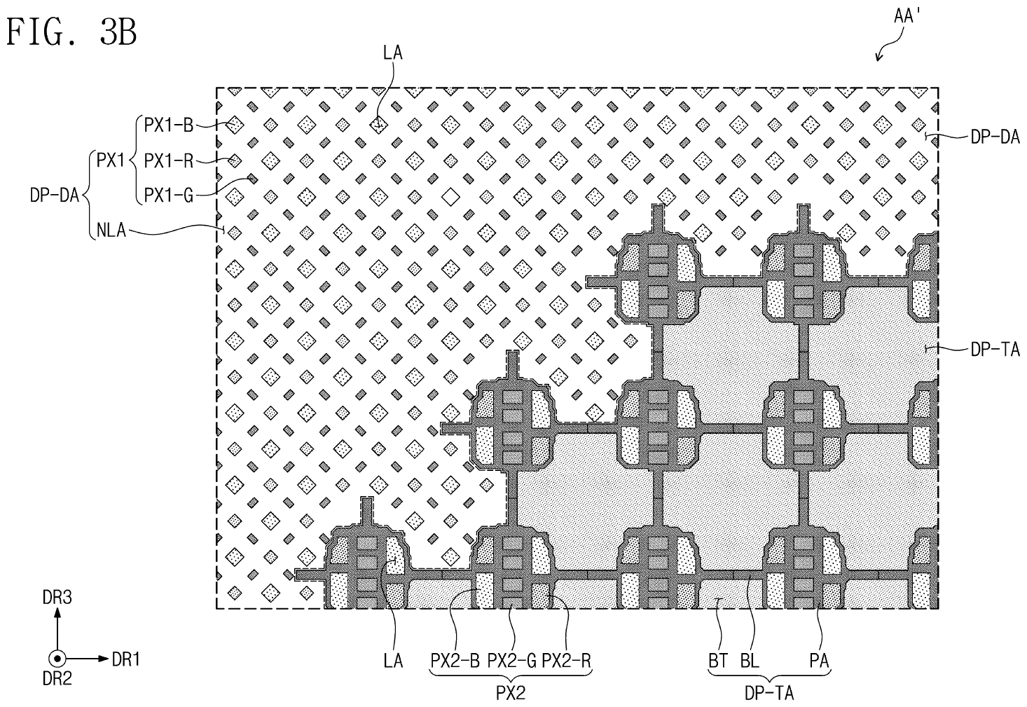

FIG. 3A is a plan view showing the display panel DP according to an embodiment of the present disclosure. FIG. 3B is a plan view showing a portion of the display panel DP. FIG. 3B is an enlarged plan view showing a portion AA′ of FIG. 3A.

Referring to FIG. 3A, the display panel DP may include the display area DP-DA and the non-display area DP-NDA around the display area DP-DA. The display area DP-DA and the non-display area DP-NDA may be distinguished from each other by the presence or absence of a pixel PX. The pixel PX may be disposed in the display area DP-DA. A scan driver SDV, a data driver, and an emission driver EDV may be disposed in the non-display area DP-NDA. The data driver may be a circuit provided in the driving chip DIC shown in FIG. 3A.

The display panel DP may include a first area AA1, a second area AA2, and a bending area BA, which are distinct from each other in the second direction DR2. The second area AA2 and the bending area BA may be areas of the non-display area DP-NDA. The bending area BA may be defined between the first area AA1 and the second area AA2.

The first area AA1 may correspond to the display surface DS of FIG. 1A. The first area AA1 may include a first non-folding area NFA10, a second non-folding area NFA20, and a folding area FAO. The first non-folding area NFA10, the second non-folding area NFA20, and the folding area FAO may correspond to the first non-folding area NFA1, the second non-folding area NFA2, and the folding area FA of FIGS. 1A to 1C, respectively.

A length in the first direction DR1 of the bending area BA and the second area AA2 may be smaller than a length in the first direction DR1 of the first area AA1. An area having a relatively short length in a bending axis direction may be relatively easily bent.

The display panel DP may include the pixels PX, a plurality of scan lines SL1 to SLm, a plurality of data lines DL1 to DLn, a plurality of emission lines EL1 to ELm, first and second control lines CSL1 and CSL2, a power line PL, and a plurality of pads PD. In the present embodiment, each of “m” and “n” is a natural number. The pixels PX may be connected to the scan lines SL1 to SLm, the data lines DL1 to DLn, and the emission lines EL1 to ELm.

The scan lines SL1 to SLm may extend in the first direction DR1 and may be connected to the scan driver SDV. The data lines DL1 to DLn may extend in the second direction DR2 and may be connected to the driving chip DIC via the bending area BA. The emission lines EL1 to ELm may extend in the first direction DR1 and may be connected to the emission driver EDV.

The power line PL may include a portion extending in the first direction DR1 and a portion extending in the second direction DR2. The portion extending in the second direction DR2 and the portion extending in the first direction DR1 may be disposed on different layers from each other. The portion of the power line PL, which extends in the second direction DR2, may extend to the second area AA2 via the bending area BA. The power line PL may provide a first voltage to the pixels PX.

The first control line CSL1 may be connected to the scan driver SDV and may extend to a lower end of the second area AA2 via the bending area BA. The second control line CSL2 may be connected to the emission driver EDV and may extend to the lower end of the second area AA2 via the bending area BA.

In a plan view, the pads PD may be disposed adjacent to the lower end of the second area AA2. The driving chip DIC, the power line PL, the first control line CSL1, and the second control line CSL2 may be connected to the pads PD. The flexible circuit film FCB may be electrically connected to the pads PD through an anisotropic conductive adhesive layer.

Referring to FIG. 3B, the sensing area DP-TA may have a light transmittance higher than a light transmittance of the display area DP-DA and may have a resolution lower than a resolution of the display area DP-DA. The light transmittance and the resolution may be measured based on a unit area. A ratio of an area occupied by a light blocking structure to an entire area may be smaller in the sensing area DP-TA than in the display area DP-DA based on the unit area. The light blocking structure may include a conductive pattern of a circuit layer, an electrode of a light emitting element, and a light blocking pattern, which are described later.

The sensing area DP-TA may have the resolution lower than the resolution of the display area DP-DA based on the unit area. The number of the pixels arranged in the sensing area DP-TA in the unit area may be smaller than the number of the pixels arranged in the display area DP-DA in the unit area (or in an area of the same size).

As shown in FIG. 3B, a first pixel PX1 may be disposed in the display area DP-DA, and a second pixel PX2 may be disposed in the sensing area DP-TA. When comparing a size of a color pixel of the first pixel PX1 and a size of a color pixel of the second pixel PX2, the color pixels having the same color may have different sizes in the first pixel PX1 and the second pixel PX2, and the color pixels having the same color in the first pixel PX1 and the second pixel PX2 may have different light emission sizes from each other. The first pixel PX1 and the second pixel PX2 may have different arrangements from each other.

FIG. 3B shows light emitting areas LA of the first pixel PX1 and the second pixel PX2 as a representative of the first pixel PX1 and the second pixel PX2. Each of the light emitting areas LA may be defined as an area where an anode of the light emitting element is exposed without being covered by a pixel definition layer. In the display area DP-DA, a non-light-emitting area NLA may be defined between the light emitting areas LA.

The first pixel PX1 may include a first color pixel PX1-R, a second color pixel PX1-G, and a third color pixel PX1-B, and the second pixel PX2 may include a first color pixel PX2-R, a second color pixel PX2-G, and a third color pixel PX2-B. Each of the first pixel PX1 and the second pixel PX2 may include a red pixel, a green pixel, and a blue pixel.

The sensing area DP-TA may include a pixel area PA, a line area BL and a transmission area BT. The second pixel PX2 may be disposed in the pixel area PA. FIG. 3B shows a structure in which two first color pixels PX2-R, four second color pixels PX2-G, and two third color pixels PX2-B are disposed in one pixel area PA, however, the present disclosure should not be limited thereto or thereby.

In the pixel area PA and the line area BL, a conductive pattern, a signal line, or a light blocking pattern, which are related to the second pixel PX2, may be disposed. The light blocking pattern may be a metal pattern and may substantially overlap the pixel area PA and the line area BL. The pixel area PA and the line area BL may be a non-transmission area.

The transmission area BT may be an area through which an optical signal passes. Since the second pixel PX2 is not disposed in the transmission area BT, the conductive pattern, the signal line, or the light blocking pattern may not be disposed in the transmission area BT. Accordingly, the transmission area BT may increase the light transmittance of the sensing area DP-TA.

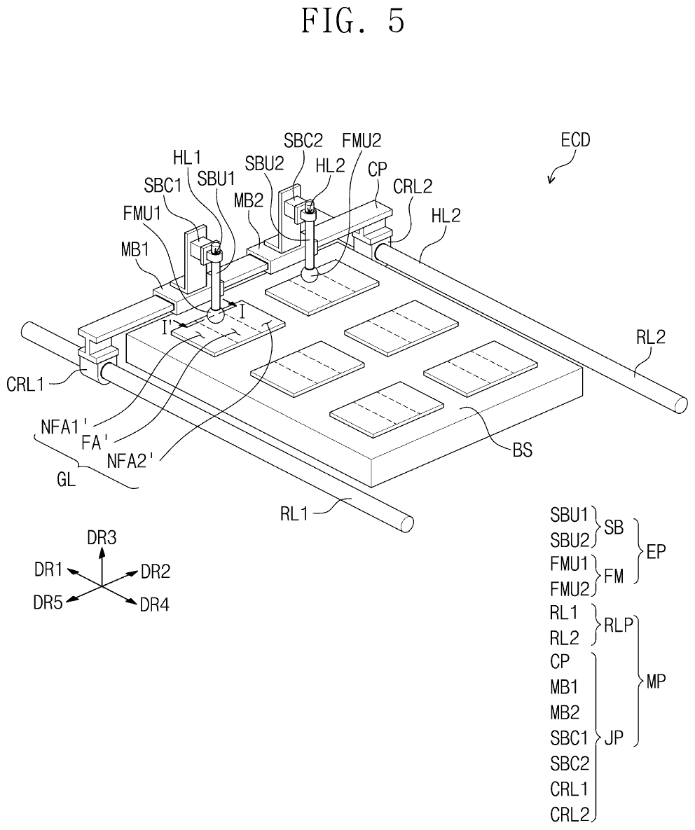

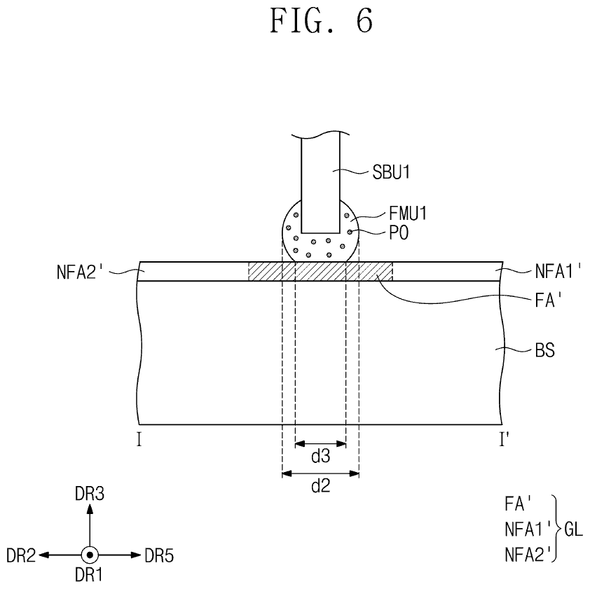

FIGS. 4 and 5 are perspective views of an etching apparatus ECD according to an embodiment of the present disclosure. The etching apparatus ECD is used to manufacture the window WM described with reference to FIG. 2A. FIG. 6 is a cross-sectional view taken along line I-I′ of FIG. 5. FIG. 5 shows an etching part EP of FIG. 4 after the etching part EP moves from its initial position to the first direction DR1. FIG. 6 shows a first unit foam FMU1 that is coupled with one end of a first unit support bar SBU1 and in contact with an upper surface of a target substrate GL.

Referring to FIGS. 4 and 5, the etching apparatus ECD may include a base part BS and the etching part EP disposed on the base part BS. The etching apparatus ECD may operate in two modes. A first mode is a mode in which a support bar SB and a foam FM are disposed adjacent to one end of the base part BS as shown in FIG. 4. A second mode is a mode in which the support bar SB and the foam FM are disposed adjacent to the other end of the base part BS, which is opposite to the one end of the based part BS, as shown in FIG. 5. A process by which the mode of the etching apparatus ECD is converted from the first mode to the second mode is called a first conversion, and a process by which the mode of the etching apparatus ECD is converted from the second mode to the first mode is called a second conversion. The user may repeatedly perform the first conversion and the second conversion alternately to etch a portion of the target substrate GL (hereinafter, referred to as an etching process).

The base part BS may support and hold the target substrate GL. The base part BS may include an acid-resistance material. The acid-resistance material may include a plastic material. The base part BS may include the plastic material. The base part BS may not be corroded by an etching solution described later.

The target substrate GL may have a thickness equal to or greater than about 15 micrometers and equal to or smaller than about 45 micrometers in the third direction DR3. The thickness of the target substrate GL may be, for example, about 30 micrometers. The target substrate GL may include a glass material. The target substrate GL may be a chemically tempered glass. Even though the target substrate GL is repeatedly folded and unfolded, the generation of creases may be reduced. The target substrate GL may include a first non-folding area NFA1′, a folding area FA′, and a second non-folding area NFA2′. The first non-folding area NFA1′, the folding area FA′, and the second non-folding area NFA2′ may correspond to the first non-folding area NFA1, the folding area FA, and the second non-folding area NFA2 shown in FIG. 1A, respectively.

Multiple target substrates GL may be arranged simultaneously on the base part BS. FIG. 4 shows the structure in which six target substrates GL are arranged on the base part BS, however, different from the structure shown in FIG. 4, the number of the target substrates GL capable of being placed on the base part BS may be changed.

The etching part EP may include the support bar SB, the foam FM, and the etching solution. The etching part EP may etch a portion of the target substrate GL.

The support bar SB may support and hold the foam FM. The support bar SB may have a bar shape extending in the third direction DR3. The support bar SB may include an acid-resistance material. The acid-resistance material may include a plastic material. The support bar SB may be formed of the plastic material. The support bar SB may not be corroded by the etching solution. The support bar SB may include a plurality of unit support bars SBU1 and SBU2. The unit support bars SBU1 and SBU2 may be arranged in the second direction DR2. The first unit support bar SBU1 and a second unit support bar SBU2 of the unit support bars SBU1 and SBU2 may be spaced apart from each other by a distance d1 equal to or greater than about 45 mm and equal to or smaller than about 500 mm in the second direction DR2. As an example, the distance d1 may be about 100 mm. The support bar SB may overlap the folding area FA′ of the target substrate GL in a plan view. The target substrates GL may be located to allow the support bar SB to pass through the folding area FA′ during the etching process.

Referring to FIGS. 5 and 6, the foam FM may be coupled with one end of the support bar SB adjacent to the base part BS. The foam FM may include a melamine resin. The foam FM may include a plurality of unit foams FMU1 and FMU2. The unit foams FMU1 and FMU2 may be connected to certain ends of the unit support bars SBU1 and SBU2, respectively. The first unit foam FMU1 of the unit foams FMU1 and FMU2 may be connected to the one end of the first unit support bar SBU1. A second unit foam FMU2 of the unit foams FMU1 and FMU2 may be connected to the one end of the second unit support bar SBU2. Each of the unit foams FMU1 and FMU2 may be directly in contact with the upper surface of the target substrate GL. Each of the unit foams FMU1 and FMU2 may be directly in contact with the upper surface of the target substrate GL in the folding area FA′. Each of the unit foams FMU1 and FMU2 may have a diameter d2 greater than a diameter d3 of an area where the unit foams FMU1 and FMU2 are directly in contact with the upper surface of the target substrate GL in the folding area FA′ in a plan view. The diameter d2 of each of the unit foams FMU1 and FMU2 may be equal to or greater than about 40 mm and equal to or smaller than about 60 mm in a plan view. As an example, the diameter d2 of the first unit foam FMU1 may be about 45 mm in a plan view. The diameter d3 of the area where the unit foams FMU1 and FMU2 are directly in contact with the upper surface of the target substrate GL in the folding area FA′ may be equal to or greater than about 20 mm and equal to or smaller than about 40 mm. As an example, the diameter d3 of the area where the first unit foam FMU1 is directly in contact with the upper surface of the target substrate GL in the folding area FA′ may be about 30 mm.

The foam FM may include a plurality of pores PO. At least some of the pores PO may be filled with the etching solution. In FIG. 6, the etching solution is not shown, however, the foam FM may be in a state where the etching solution is provided in at least one of the pores PO. The etching solution may stay in the plurality of pores PO for a certain period of time due to a surface tension. In the etching process, a portion of the etching solution may be provided on the upper surface of the target substrate GL. The portion of the target substrate GL may be etched by the etching solution.

The etching solution may include at least one of ammonium fluoride, sulfuric acid, and nitric acid. The etching solution may include ammonium fluoride, sulfuric acid, and nitric acid. The ammonium fluoride is present in an amount equal to or more than 10 wt % and equal to or less than 15 wt % by weight of the etching solution, the sulfuric acid is present in an amount equal to or more than 2 wt % and equal to or less than 7 wt % by weight of the etching solution, and the nitric acid is present in an amount equal to or more than 1 wt % and equal to or less than 5 wt % by weight of the etching solution. As an example, the ammonium fluoride may be present in an amount of about 10 wt % by weight of the etching solution, the sulfuric acid may be present in an amount of about 2 wt % by weight of the etching solution, and the nitric acid may be present in an amount of about 1 wt % by weight of the etching solution.

The etching apparatus ECD may further include a moving part MP coupled with the etching part EP. The moving part MP may move the etching part EP in one direction or a direction opposite to the one direction. The moving part MP may include a rail part RLP and a joint part JP.

The rail part RLP may guide the etching part EP to move in the first direction DR1 and a fourth direction DR4 during the etching process. The rail part RLP may include a first rail RL1 disposed adjacent to one side of the base part BS and extending in one direction and a second rail RL2 disposed opposite to the first rail RL1 with respect to the base part BS and extending in the one direction. The rail part RLP may include the first rail RL1 extending in the first direction DR1 and the second rail RL2 opposite to the first rail RL1 and extending in the first direction DR1. The second rail RL2 may be spaced apart from the first rail RL1 in the second direction DR2. The base part BS may be disposed between the first rail RL1 and the second rail RL2.

The joint part JP may support the etching part EP and the rail part RLP to allow the etching part EP to move in the first direction DR1 and the fourth direction DR4 during the etching process. The joint part JP may include a first-rail joint part CRL1, a second-rail joint part CRL2, a body part CP, a first support bar joint part SBC1, a second support bar joint part SBC2, a first-support moving part MB1, and a second-support moving part MB2.

The first-rail joint part CRL1 and the second-rail joint part CRL2 may be coupled with the first rail RL1 and the second rail RL2, respectively. The first-rail joint part CRL1 may move in the first direction DR1 and the fourth direction DR4 along the first rail RL1. The second-rail joint part CRL2 may move in the first direction DR1 and the fourth direction DR4 along the second rail RL2. When the first-rail joint part CRL1 and the second-rail joint part CRL2 move along the first direction DR1 or the fourth direction DR4, other elements of the joint part JP and the etching part EP move with the first-rail joint part CRL1 and the second-rail joint part CRL2 along the first direction DR1 or the fourth direction DR4, while the first rail RL1 and the second rail RL2 don't move.

The body part CP may be directly coupled with and may support the first-rail joint part CRL1 and the second-rail joint part CRL2. The first-rail joint part CRL1 and the second-rail joint part CRL2 may be connected to each other by the body part CP. The body part CP may extend in the second direction DR2.

The first support bar joint part SBC1 and the second support bar joint part SBC2 may be coupled with the first unit support bar SBU1 and the second unit support bar SBU2, respectively. A first hole HL1 and a second hole HL2 may be defined through the first support bar joint part SBC1 and the second support bar joint part SBC2, respectively. A diameter of the unit support bars SBU1 and SBU2 in a plan view may be substantially the same as a diameter of each of the first hole HL1 and the second hole HL2 in a plan view. At least a portion of the first unit support bar SBU1 may be disposed in the first hole HL1 and may be coupled with the first support bar joint part SBC1. At least a portion of the second unit support bar SBU2 may be disposed in the second hole HL2 and may be coupled with the second support bar joint part SBC2.

The first-support moving part MB1 may connect the body part CP and the first support bar joint part SBC1 and may support the body part CP and the first support bar joint part SBC1. The first-support moving part MB1 may move in the second direction DR2 and a fifth direction DR5. The first-support moving part MB1 may allow the first support bar joint part SBC1 to move in the second direction DR2 and the fifth direction DR5. The first support bar joint part SBC1 may allow the user to easily change a position of the first unit support bar SBU1 coupled with the first support bar joint part SBC1. The second-support moving part MB2 may connect the body part CP and the second support bar joint part SBC2 and may support the body part CP and the second support bar joint part SBC2. The second-support moving part MB2 may move in the second direction DR2 and the fifth direction DR5. The second-support moving part MB2 may allow the second support bar joint part SBC2 to move in the second direction DR2 and the fifth direction DR5. The second support bar joint part SBC2 may allow the user to easily change a position of the second unit support bar SBU2 coupled with the second support bar joint part SBC2.

The etching apparatus ECD according to the present disclosure may include the base part BS and the etching part EP disposed on the base part BS, and the etching part EP may include the support bar SB, the foam FM, and the etching solution. The etching apparatus ECD may easily provide the etching solution to the folding area FA′ of the target substrate GL during the etching process. Thus, the difficulty of the process of etching the portion of the target substrate GL may be reduced, and costs of the etching process may be reduced.

Hereinafter, a method of manufacturing the window using the etching apparatus according to the present disclosure will be described, and detailed descriptions of the components described with reference to FIGS. 4 to 6 will be omitted.

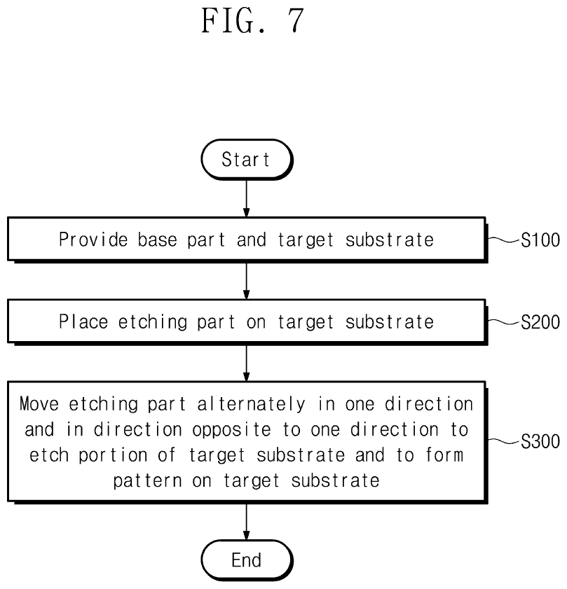

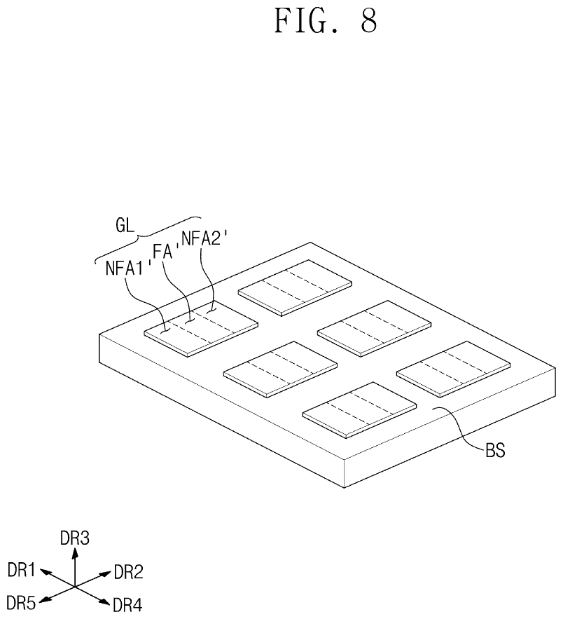

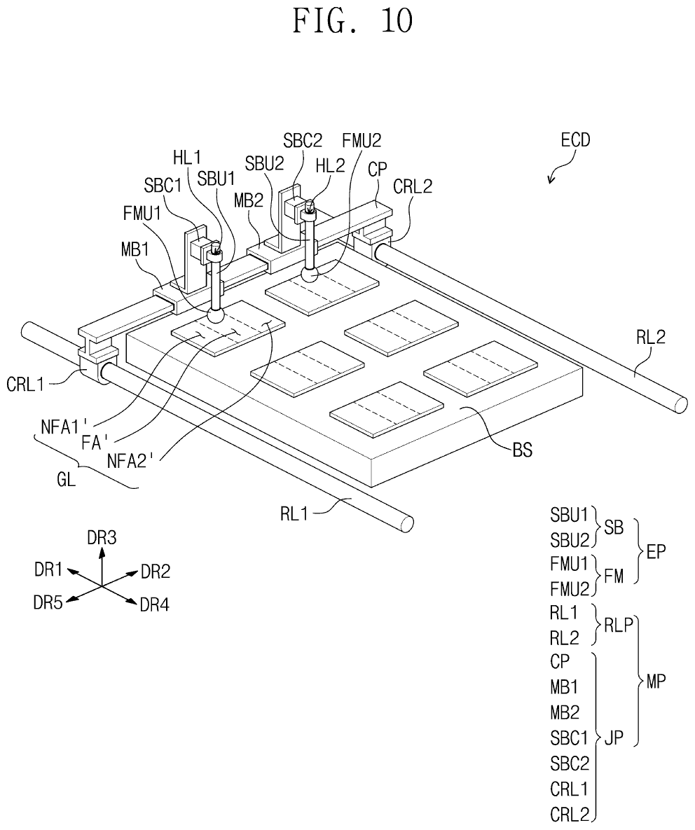

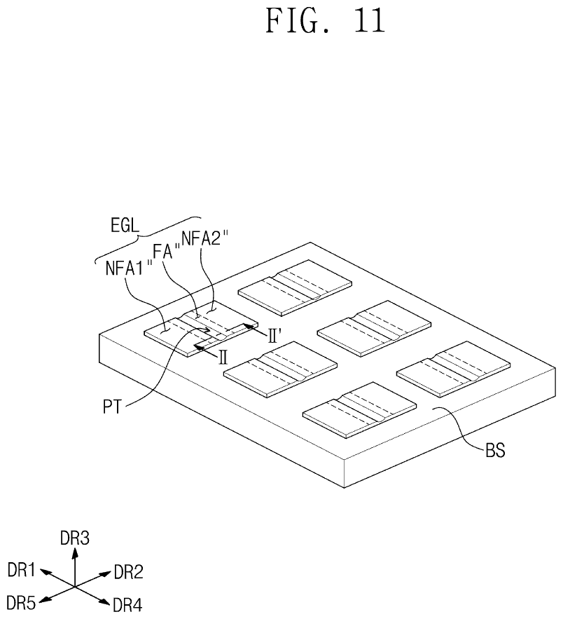

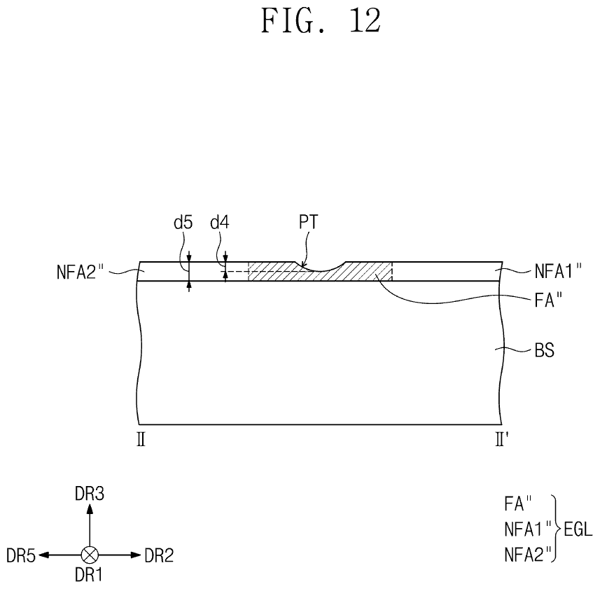

FIG. 7 is a flowchart illustrating the manufacturing method of the window according to an embodiment of the present disclosure. FIGS. 8 to 11 are views illustrating the manufacturing method of the window according to an embodiment of the present disclosure. FIG. 12 is a cross-sectional view taken along line II-II′ of FIG. 11.

Referring to FIG. 7, the manufacturing method of the window includes providing the base part and the target substrate (S100), placing the etching part on the target substrate (S200), and moving the etching part alternately in the one direction and in the direction opposite to the one direction to etch the portion of the target substrate and to form a pattern on the target substrate (S300).

Referring to FIG. 8, the target substrate GL may be disposed directly on the base part BS in the providing of the base part BS and the target substrate GL. The target substrate GL may be provided in plural. The target substrates GL may be arranged parallel to each other in the first direction DR1 and the second direction DR2. When the plural target substrates GL are provided, the efficiency of the manufacturing method of the window may be improved since the plural target substrates GL may be etched through a single etching process.

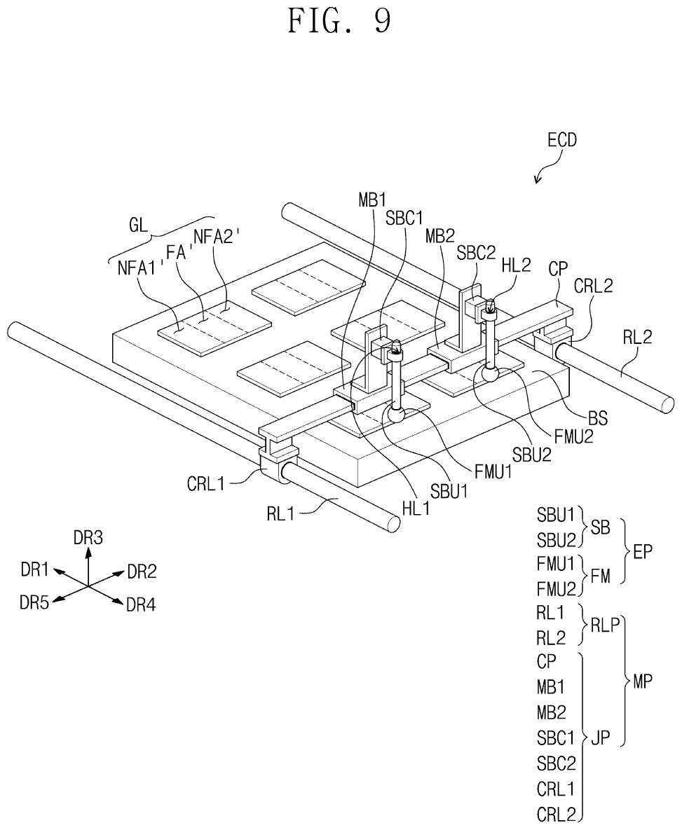

Referring to FIG. 9, the etching part EP may be disposed to allow each of the unit foams FMU1 and FMU2 to be in contact with the upper surface of the target substrate GL in the placing of the etching part EP. Each of the unit foams FMU1 and FMU2 may be disposed to be in contact with the folding area FA′ of each of the target substrates GL in the placing of the etching part EP.

The manufacturing method of the window may further include providing the etching solution to the pores PO (refer to FIG. 6) of the foam FM before the forming of the pattern PT (refer to FIG. 11). In the providing of the etching solution to the pores PO (refer to FIG. 6) of the foam FM, the foam FM may be directly in contact with the etching solution filled in a container, e.g. a beaker. However, the providing of the etching solution to the pores PO (refer to FIG. 6) of the foam FM should not be particularly limited, and according to an embodiment, the etching solution may be sprayed onto the foam FM.

Referring to FIGS. 9 to 11, the forming of the pattern PT may include the alternate moving of the etching part EP in the one direction and the direction opposite to the one direction. The alternate moving of the etching part EP in the one direction and the direction opposite to the one direction may be performed repeatedly about 200 times or more and about 1000 times or less. The forming of the pattern PT may include the alternate moving of the etching part EP in the first direction DR1 and the fourth direction DR4 opposite to the first direction DR1, that is repeatedly performed about 200 times or more and about 1000 times or less. The alternate moving of the etching part EP in the first direction DR1 and the fourth direction DR4 opposite to the first direction DR1, that is repeatedly performed about 200 times or more and about 1000 times or less may be an operation that alternately performs the first conversion and the second conversion about 200 times or more and about 1000 times or less to etch the portion of the target substrate GL. As an example, the user may alternately perform each of the first conversion and the second conversion about 500 times to form the pattern PT.

After the repeatedly moving the etching part EP, the portion of the target substrate GL may be etched, and a substrate EGL including the pattern PT may be formed. The substrate EGL including the pattern PT may be provided after repeatedly moving the etching part EP about 200 times or more and about 1000 times or less.

Referring to FIG. 12, the substrate EGL may include a first non-folding area NFA1″, a folding area FA″, and a second non-folding area NFA2″. The first non-folding area NFA1″, the folding area FA″, and the second non-folding area NFA2″ may correspond to the first non-folding area NFA1, the folding area FA, and the second non-folding area NFA2 shown in FIG. 1A, respectively. The first non-folding area NFA1″, the folding area FA″, and the second non-folding area NFA2″ may correspond to the first non-folding area NFA1′, the folding area FA′, and the second non-folding area NFA2′ shown in FIG. 4, respectively.

The pattern PT may be formed in the folding area FA″. The pattern PT may include a recess extending in one direction. The pattern PT may include a recess extending in the first direction DR1. The recess defined in the pattern PT may have a depth d4 smaller than a thickness d5 of the target substrate GL in the third direction DR3. The thickness d5 of the target substrate GL may correspond to a thickness of the substrate EGL in the first non-folding area NFA1″ or the second non-folding area NFA2″. The substrate EGL including the pattern PT may be used as the window WM (refer to FIG. 2A) of the electronic device ED (refer to FIG. 2A).

According to the manufacturing method of the window, the etching solution may be easily provided onto the folding area of the target substrate through the etching process. Thus, the difficulty of the process of etching the portion of the target substrate GL may be reduced, and costs of the etching process may be reduced.

Although the embodiments of the present disclosure have been described, it is understood that the present disclosure should not be limited to these embodiments but various changes and modifications can be made by one ordinary skilled in the art within the spirit and scope of the present disclosure as hereinafter claimed. Therefore, the disclosed subject matter should not be limited to any single embodiment described herein, and the scope of the present invention shall be determined according to the attached claims.

What is claimed is:

1. An etching apparatus comprising:
a base part; and
an etching part disposed on the base part, the etching part comprising:
a support bar;
a foam coupled with one end of the support bar and provided with a plurality of pores, wherein the one end is adjacent to the base part; and
an etching solution provided in the pores.

2. The etching apparatus of claim 1, wherein the support bar comprises a plurality of unit support bars, and the foam comprises a plurality of unit foams coupled with one end of the unit support bars, respectively.

3. The etching apparatus of claim 2, wherein a distance between one unit support bar among the unit support bars and another unit support bar adjacent to the one unit support bar is equal to or greater than about 45 millimeters (mm) and equal to or smaller than about 500 mm.

4. The etching apparatus of claim 1, wherein the base part and the support bar comprise an acid-resistance material.

5. The etching apparatus of claim 4, wherein the acid-resistance material comprises a plastic material.

6. The etching apparatus of claim 1, wherein the foam comprises a melamine resin.

7. The etching apparatus of claim 1, wherein the etching solution comprises at least one of ammonium fluoride, sulfuric acid, and nitric acid.

8. The etching apparatus of claim 7, wherein the etching solution comprises the ammonium fluoride, the sulfuric acid, and the nitric acid,
the ammonium fluoride is in an amount equal to or more than 10 weight percentages (wt %) and equal to or less than 15 wt % by weight of the etching solution, the sulfuric acid is in an amount equal to or more than 2 wt % and equal to or less than 7 wt % by weight of the etching solution, and the nitric acid is in an amount equal to or more than 1 wt % and equal to or less than 5 wt % by weight of the etching solution.

9. The etching apparatus of claim 1, wherein the foam has a diameter equal to or greater than about 40 mm and equal to or smaller than about 60 mm in a plan view.

10. The etching apparatus of claim 1, further comprising a moving part coupled with the etching part.

11. The etching apparatus of claim 10, wherein the moving part is configured to move the etching part in one direction and a direction opposite to the one direction.

12. The etching apparatus of claim 11, wherein the moving part comprises:
a rail part comprising a first rail disposed adjacent to one side of the base part and extending in the one direction and a second rail disposed opposite to the first rail with respect to the base part and extending in the one direction; and
a joint part comprising a first-rail joint part coupled with the first rail, a second-rail joint part coupled with the second rail, and a support bar joint part coupled with the support bar.

13. A method of manufacturing a window, comprising:
providing a base part and a target substrate disposed on the base part;
placing an etching part, which comprises a support bar, a foam provided with a plurality of pores, and an etching solution provided in the pores, on the target substrate, wherein the form is coupled with one end of the support bar adjacent to the target substrate; and
moving the etching part alternately in one direction and in a direction opposite to the one direction to etch a portion of the target substrate and to form a pattern on the target substrate.

14. The method of claim 13, wherein a diameter of an area where the foam is in contact with the target substrate is equal to or greater than about 20 mm and equal to or smaller than about 40 mm in a plan view in the placing of the etching part.

15. The method of claim 13, wherein the etching part alternately moves in the one direction and the direction opposite to the one direction, respectively, equal to or greater than about 200 times and equal to or smaller than about 1000 times in the forming of the pattern.

16. The method of claim 13, wherein the target substrate comprises a glass material.

17. The method of claim 13, wherein the target substrate comprises a first non-folding area, a second non-folding area spaced apart from the first non-folding area, and a folding area disposed between the first non-folding area and the second non-folding area in a plan view, and the pattern is formed in the folding area.

18. The method of claim 17, wherein the pattern is provided with a recess defined in the folding area and extending in the one direction, and a depth of the recess is smaller than a thickness of the target substrate.

19. The method of claim 13, wherein the etching part is coupled with a moving part, and the moving part moves the etching part in the one direction or the direction opposite to the one direction.

20. The method of claim 19, wherein the moving part comprises:
a rail part comprising a first rail disposed adjacent to one side of the base part and extending in the one direction and a second rail disposed opposite to the first rail with respect to the base part and extending in the one direction; and
a joint part comprising a first-rail joint part coupled with the first rail, a second-rail joint part coupled with the second rail, and a support bar joint part coupled with the support bar.
